(19) United States
(12) Patent Application Publication
(10) Pub. No.: US 2026/0075586 A1
(43) Pub. Date: Mar. 12, 2026

(54) METHOD AND DEVICE FOR PAGING EARLY INDICATION (PEI), STORAGE MEDIUM AND TERMINAL DEVICE

(71) Applicant: Beijing Xiaomi Mobile Software Co., Ltd., Beijing (CN)

(72) Inventors: Xiaofei LIU, Beijing (CN); Yumin WU, Beijing (CN)

(73) Assignee: Beijing Xiaomi Mobile Software Co., Ltd., Beijing (CN)

(21) Appl. No.: 19/107,210

(22) PCT Filed: Sep. 2, 2022
(86) PCT No.: PCT/CN2022/116900

§ 371 Date: Feb. 27, 2025

(51) Int. Cl. H04W 68/02; H04W 76/27

(52) U.S. Cl. CPC H04W 68/02; H04W 76/27

(57) ABSTRACT

A method for paging early indication (PEI), including: receiving a PEI transmitted by a network device, where the PEI is configured to inform the terminal whether to monitor a paging message related to an inactive multicast service.

### CROSS-REFERENCE TO RELATED APPLICATION

The present application is a U.S. National Stage of International Application No. PCT/CN2022/116900, filed on Sep. 2, 2022, the contents of all of which are incorporated herein by reference in their entirety for all purposes.

### BACKGROUND OF THE INVENTION

With the development of communication technology and the enrichment of demand, as well as the increasing perfection of standard formulation for the fifth generation communication technology, three states, including an idle state, an inactive state and a connected state, are defined in New Radio (NR). A Multicast and Broadcast Service (MBS) includes a multicast service. The multicast service allows a same content to be transmitted to a plurality of recipients.

### SUMMARY OF THE INVENTION

The present disclosure relates to the technical field of communications, and in particular, to a method and device for paging early indication (PEI), a storage medium and a terminal.

According to a first aspect of the embodiments of the present disclosure, a method for paging early indication (PEI) is provided. The method is performed by a terminal and includes: receiving a PEI transmitted by a network device, where the PEI is configured to inform the terminal whether to monitor a paging message related to an inactive multicast service.

According to a second aspect of the embodiments of the present disclosure, a method for paging early indication (PEI) is provided. The method is performed by a network device and includes: transmitting a PEI to a terminal, where the PEI is configured to inform the terminal whether to monitor a paging message related to an inactive multicast service.

According to a third aspect of the embodiments of the present disclosure, a device for paging early indication (PEI) is provided. The device is applied to a terminal and includes: a receiving module, configured to receive a PEI transmitted by a network device, where the PEI is configured to inform the terminal whether to monitor a paging message related to an inactive multicast service.

According to a fourth aspect of the embodiments of the present disclosure, a device for paging early indication (PEI) is provided. The device is applied to a network device and includes: a transmitting module, configured to transmit a PEI to a terminal, where the PEI is configured to inform the terminal whether to monitor a paging message related to an inactive multicast service.

According to a fifth aspect of the embodiments of the present disclosure, a terminal is provided. The terminal includes: one or more first processors; and a first memory that stores first processor-executable instructions, where the one or more first processors are configured to execute the first processor-executable instructions to implement the method for paging early indication (PEI) provided in the first aspect of the present disclosure.

According to a sixth aspect of the embodiments of the present disclosure, a network device is provided. The network device includes: one or more second processors, and a second memory that stores second processor-executable instructions, where the one or more second processors are configured to execute the second processor-executable instructions to implement the method for paging early indication (PEI) provided in the second aspect of the present disclosure.

According to a seventh aspect of the embodiments of the present disclosure, a non-transitory computer-readable storage medium is provided. The non-transitory computer-readable storage medium stores computer program instructions, where the computer program instructions, when executed by one or more processors, implement the steps of the method for paging early indication (PEI) provided in the first aspect or the second aspect of the present disclosure.

According to an eighth aspect of the embodiments of the present disclosure, a chip is provided. The chip includes one or more processors and an interface, where the one or more processors are configured to read instructions to perform the method for paging early indication (PEI) provided in the first aspect or the second aspect of the present disclosure.

### BRIEF DESCRIPTION OF DRAWINGS

The above and/or additional aspects and advantages of the present disclosure will be obvious and easy to understand from the following description of embodiments taken in conjunction with the accompanying drawings.

FIGS. 1A to 1B are conversion diagrams of an RRC connected state, an inactive state, and an idle state.

FIG. 2 is an application scenario to which a method for paging early indication (PEI) is applicable according to some embodiments.

FIG. 3 is a flowchart of a method for paging early indication (PEI) according to some embodiments.

FIG. 4 is a flowchart of a method for paging early indication (PEI) according to other embodiments.

FIG. 5 is a communication sequence diagram of a method for paging early indication (PEI) according to other embodiments.

FIG. 6 is a flowchart of a method for paging early indication (PEI) according to yet other embodiments.

FIG. 7 is a communication sequence diagram of a method for paging early indication (PEI) according to yet other embodiments.

FIG. 8 is a flowchart of a method for paging early indication (PEI) according to still other embodiments.

FIG. 9 is a communication sequence diagram of a method for paging early indication (PEI) according to still other embodiments.

FIG. 10 is a flowchart of a method for paging early indication (PEI) according to some embodiments.

FIG. 11 is a flowchart of a method for paging early indication (PEI) according to other embodiments.

FIG. 12 is a flowchart of a method for paging early indication (PEI) according to yet other embodiments.

FIG. 13 is a block diagram of a device for paging early indication (PEI) according to some embodiments.

FIG. 14 is a block diagram of a device for paging early indication (PEI) according to some embodiments.

FIG. 15 is a block diagram of a terminal according to some embodiments.

FIG. 16 is a block diagram of a network device according to some embodiments.

### DETAILED DESCRIPTION OF THE INVENTION

Example embodiments will be described in detail here, examples of which are shown in the accompanying drawings. When the following description refers to the accompanying drawings, the same numerals in different accompanying drawings represent the same or similar elements, unless otherwise indicated. The implementations as described in the following example embodiments do not represent all implementations consistent with the present disclosure, and rather, are merely examples of devices and the methods consistent with some aspects of the present disclosure as detailed in the appended claims.

In order to facilitate understanding the embodiments of the present disclosure, some terms in the embodiments of the present disclosure are explained below to facilitate the understanding of those skilled in the art.

### 1) Terminal

The terminal includes a device that provides at least one of voice or data connectivity for a user, for example, includes a device that provides voice for the user, or includes a device that provides data connectivity for the user, or includes a device that provides voice and data connectivity for the user. For example, the terminal may include a handheld device with a wireless connection function or a processing device connected to a wireless modem. For another example, the terminal may include a user equipment (UE), a wireless terminal, a mobile terminal, a user device, etc.

### 2) Network Device

The network device, also known as radio access network device, is a device that connects the terminal to a wireless network, and may include an access network device, may also include a core network device, and may further include a service provider device (such as a server), etc. For example, the network device includes but is not limited to: a transmission reception point (TRP), a base station (e.g., gNB), a radio network controller (RNC), a Node B (NB), a base station controller (BSC), a base transceiver station (BTS), a home evolved NodeB (HeNB) or a home NodeB (HNB), a baseband unit (BBU), etc.

The terminal can establish a radio resource control (RRC) connection with the network device during or after connecting to the network device. After the terminal establishes the RRC connection with the network device, an RRC state of the terminal is an RRC connected (RRC_CONNECTED) state.

### 3) RRC Connected State

The RRC connected state may also be referred to as connected state for short. In the disclosure, “connected state” and “RRC connected state” are the same concept and the two terms are interchangeable. The terminal establishes an RRC connection with a network, so that data can be transmitted.

### 4) RRC Idle State

The RRC idle state may also be referred to as idle state for short. In the disclosure, “idle state” and “RRC idle state” are the same concept and the two terms are interchangeable. The RRC idle state means that an RRC connection between the terminal and the network device has not been established, and a connection between the network device corresponding to the terminal and a core network device has not been established. During the terminal is in the idle state, in a case where there is data to be transmitted, it is necessary to establish the connection between the terminal and the network device, and the connection between the network device and the core network device before data transmission.

### 5) RRC Inactive State

The RRC inactive state may also be referred to as inactive state for short. In the disclosure, “deactivation state”, “deactivated state”, “inactive state”, “RRC inactive state” or “RRC deactivated state”, etc. are the same concept, and these terms are interchangeable. The RRC inactive state means that the RRC connection between the terminal and the network device has been disconnected, but the connection between the network device corresponding to the terminal and the core network device has not been disconnected. During the terminal is in the deactivated state, in a case where there is data to be transmitted, it is necessary to restore the RRC connection between the terminal and the network device before data transmission.

### 6) Paging Mechanism

The network device may transmit paging to terminals which are in an idle state, an inactive state and a connected state. The paging process may be triggered by the core network to inform a certain terminal to receive a paging request, or triggered by an eNodeB/gNB to inform the system information update and inform the terminal to receive information about an Earthquake and Tsunami Warning System (ETWS), a Commercial Mobile Alert System (CMAS), etc.

In a Discontinuous Reception (DRX) cycle, the terminal can monitor a Physical Downlink Control Channel (PDCCH) merely on a paging occasion (PO) on a corresponding paging frame (PF), that is, monitor whether the PDCCH carries a Paging Radio Network Temporary Identity (P-RNTI), and then judge whether a corresponding Physical Downlink Shared Channel (PDSCH) bears a paging message.

In a case of parsing that the PDCCH carries the P-RNTI, the terminal receives data on the PDSCH according to a PDSCH parameter indicated on the PDCCH. In a case where the paging message (data on the PDSCH) received by the terminal carries a list of UE IDs, the terminal can match its own UE ID with the UE ID carried in the paging message to judge whether the paging message is paging the terminal. In a case of not parsing that the PDCCH carries the P-RNTI, the terminal may go to sleep according to the DRX cycle without receiving the PDCCH physical channel.

### 7) PEI (Paging Early Indication)

The PEI is configured to inform the terminal whether to receive paging indication information. In a case where the PEI indicates that the terminal needs to receive the paging indication information, the terminal may monitor a paging occasion.

At present, for the idle state or the inactive state, the network device may search for the terminal through a paging mechanism. In a case of having downlink data or signaling to be transmitted, the network device may transmit a paging message to enable the terminal to initiate an RRC connection establishment or connection recovery process to make the terminal return to the RRC connection state. In addition, a paging short message may also be transmitted to inform UEs in all states under network coverage to receive system message update, and inform early warning information about the ETWS, the CMAS, etc.

During being in the idle state or the inactive state, the terminal can use DRX to monitor the paging, and monitor one paging occasion (PO) in each DRX cycle, where the PO may include a plurality of PDCCH monitoring occasions. The PDCCH monitoring occasions may be configured to transmit paging downlink control information (paging DCI), where the paging downlink control information is configured to instruct the UE to decode a corresponding PDSCH to acquire the paging message.

Each paging frame in the DRX may include a plurality of POs, and each PO may include a plurality of PDCCH monitoring occasions. Each PDCCH monitoring occasion may be mapped into a paging search space configured by the network device according to a parameter “first PDCCH-Monitoring Occasion Of PO”. The search space is configured to provide a time-domain position of PDCCH monitoring. The first PDCCH-Monitoring Occasion Of PO is configured to indicate a position where the first PDCCH monitoring occasion of each PO starts in the paging search space.

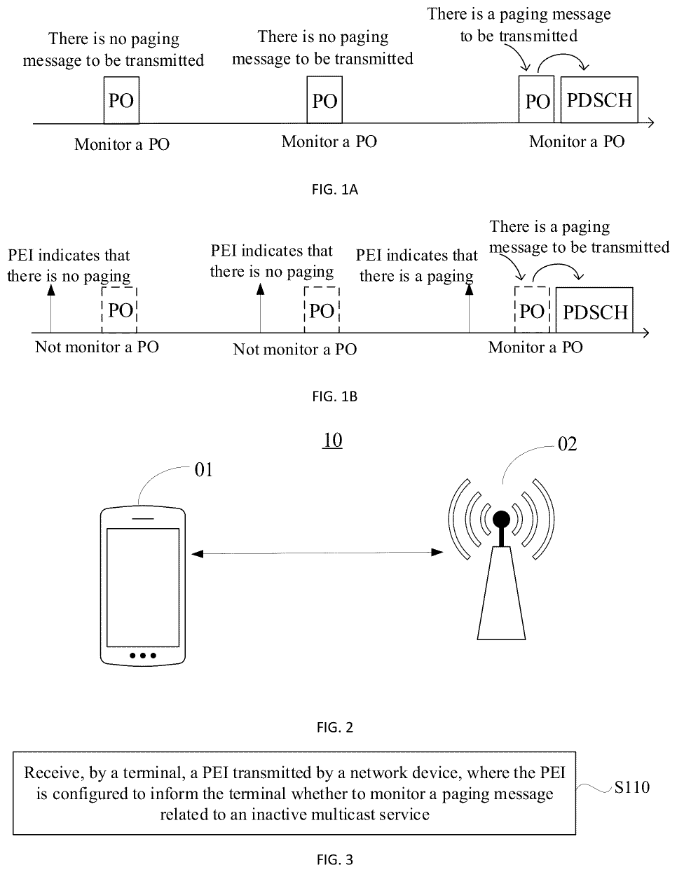

Existing terminal needs to perform paging monitoring on one PO in each DRX cycle, but not in each DRX cycle there may be a paging message transmitted by the network device. In order to avoid unnecessary paging monitoring of the terminal, a paging early indication (PEI) is introduced. The paging early indication (PEI) judges in advance whether there is a paging message to be transmitted, so as to indicate whether the terminal needs to perform a paging process. In a case where it is indicated that there is no paging to be transmitted, the terminal may not monitor the PDCCH monitoring occasion of the PO, so as to achieve the purpose of power saving. To better understand the role of the PEI, an embodiment of the present disclosure gives example diagrams as shown in FIGS. 1A to 1B. As can be seen from FIG. 1A, before the PEI is introduced, the terminal needs to perform paging every DRX cycle, that is, needs to perform PO monitoring no matter whether there is a message to be transmitted or there is no message to be transmitted. As can be seen from FIG. 1B, after the PEI is introduced, the terminal may perform PO monitoring after receiving the PEI, so that the power consumption can be reduced.

At present, there are two transmission modes for an MBS service. The first transmission mode is a multicast transmission mode. In the multicast transmission mode, the terminal enters a connected state (RRC_CONNECTED) to receive transmission configuration information of the MBS service, so as to receive the MBS service, and the network device may also transmit reception configuration information of the MBS service to the terminal through UE-specific signaling. The second transmission mode is a broadcast transmission mode. In the broadcast transmission mode, the terminal may receive the transmission configuration information of the MBS service in an idle state (IDLE), an inactive state (INACTIVE), or a connected state (CONNECTED) and receive the MBS service, and the network device may transmit the reception configuration information of the MBS service to the terminal through system information such as System Information Block (SIB) and through MBS control channel information, such as MBS Control Channel (MCCH).

Therefore, the related art cannot support the reception of an inactive multicast service, and the reception of multicast service data cannot be performed in a case where the terminal is in the inactive state. In addition, in a case where the reception of multicast service data is performed in a case where the terminal is in the inactive state, the terminal can be informed by means of a paging message in a case where a reception configuration for the inactive multicast service is updated. In order to enable the terminal to distinguish a legacy paging message from a target paging message, the network device can configure an independent paging message configuration for the target paging message, which, however, will additionally increase the power consumption of monitoring by the terminal. The target paging message may be a paging message related to the informed inactive multicast service.

At present, there is no relevant solution on how to update a configuration for an inactive multicast service.

In order to solve the above problems, the embodiments of the present disclosure provide a method and device for paging early indication (PEI), a storage medium and a terminal, so as to reduce the power consumption of monitoring by the terminal.

Application environments 10 of a method for paging early indication (PEI) provided by the embodiment of the present disclosure will be described below. As shown in FIG. 2, the application environment 10 may include a terminal 01 and a network device 02, where the terminal 01 and the network device 02 may be connected by wired or wireless connection.

The terminal 01 may be a user equipment (UE), a mobile station (MS), a mobile terminal (MT), etc. For example, the terminal 01 may be a mobile phone, a tablet computer or a computer with a wireless transceiving function, and may also be a virtual reality (VR) terminal, an augmented reality (AR) terminal, a wireless terminal in industrial control, a wireless terminal in unmanned driving, a wireless terminal in telemedicine, a wireless terminal in smart grid, a wireless terminal in smart city, smart home, a vehicle terminal, etc.

The network device 02 may include an access network device, may also include a core network device, and may further include a service provider device (such as a server), which will not be limited. The network device 02 is configured to realize the functions such as resource scheduling, radio resource management, and radio access control for the terminal 01. In an example, the network device 02 may be a small base station, a wireless access point, a transmission receive point (TRP), a transmission point (TP), or any one of other access nodes of a certain type.

FIG. 3 is a flowchart of a method for paging early indication (PEI) according to some embodiments. As shown in FIG. 3, the method for paging early indication (PEI) may be performed by the terminal 01 in FIG. 2, and includes the following step S110.

In step S110, the terminal receives a PEI transmitted by a network device, where the PEI is configured to inform the terminal whether to monitor a paging message related to an inactive multicast service.

In an embodiment of the present disclosure, the terminal may support the reception of an inactive multicast service, that is, in a case of being in an inactive state, the terminal may also continue to perform the reception of multicast service data. Therefore, in a case of being in the inactive state, the terminal may acquire a configuration for the inactive multicast service, and perform the inactive multicast service using the configuration for the inactive multicast service.

In an example, the terminal may receive the PEI from the network device, where the PEI may be configured to inform the terminal whether to monitor a paging message related to an inactive multicast service.

In some implementations, after receiving the PEI transmitted by the network device, the terminal may determine, based on the PEI, whether to monitor a paging message related to the inactive multicast service. In a case where the PEI received by the terminal indicates to monitor the paging message related to the inactive multicast service, the terminal monitors the paging message related to the inactive multicast service on a PO after receiving the PEI. In addition, in a case where the PEI received by the terminal indicates not to monitor the paging message related to the inactive multicast service, the terminal does not monitor the paging message related to the inactive multicast service on the PO after receiving the PEI.

Through the above introduction, it is known that in a case of being in the inactive state, the terminal may also continue to perform the reception of the multicast service data. In this process, the terminal may receive the PEI transmitted by the network device. Based on this, in a case where the PEI indicates to monitor a paging message related to an inactive multicast service, the terminal monitors the paging message related to the inactive multicast service on a PO after receiving the PEI.

In an example, in a case where a paging message related to an inactive multicast service is monitored on a PO, the terminal may perform according to the paging message at least one of the following operations including but not limited to: updating a configuration for the inactive multicast service; activating a configuration for the inactive multicast service; deactivating a configuration for the inactive multicast service; releasing a configuration for the inactive multicast service; or suspending a configuration for the inactive multicast service.

An embodiment of the present disclosure specifies that the terminal may receive a PEI transmitted by a network device, where the PEI is configured to inform the terminal whether to monitor a paging message related to an inactive multicast service. In this way, the power consumption of monitoring the paging message related to the inactive multicast service can be reduced.

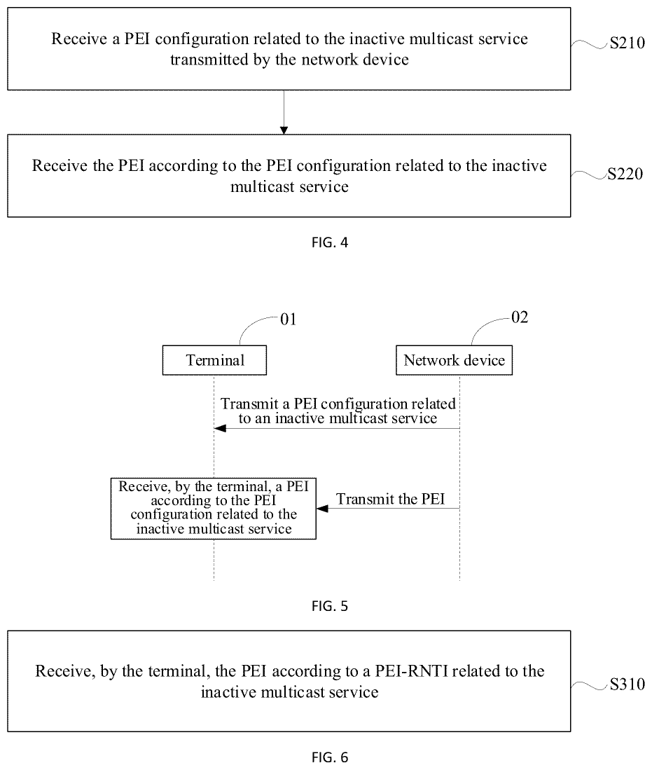

FIG. 4 is a flowchart of a method for paging early indication (PEI) according to other embodiments. As shown in FIG. 4, the method for paging early indication (PEI) may be performed by the terminal 01 in FIG. 2, and includes the following steps S210-S220.

In step S210, the terminal receives a PEI configuration related to the inactive multicast service transmitted by the network device.

In an embodiment of the present disclosure, the terminal may receive a PEI configuration related to the inactive multicast service transmitted by the network device. The PEI configuration related to the inactive multicast service may include at least one of: a number of paging monitoring occasions associated with each PEI (po-Num Per PEI); PEI frame offset (pei-Frame Offset); payload size of downlink control information related to PEI (payload Size DCI); subgroup configuration (subgroup Config); or indication for monitoring PEI (last Used Cell Only).

As an example, the number of POs related to the PEI is four, and these four POs may be PO1, PO2, PO4, and PO8, respectively.

In some implementations, the PEI frame offset is a number of frames that can start from a reference frame of a PEI-O (PEI Occasion) to a first paging frame associated with the PEI-O. The indication for monitoring the PEI is configured to monitor the PEI in a case where the latest RRC Release is received and it is determined that the RRC Release does not contain “no Last Cell Update”. A value of the indication for monitoring PEI can be TRUE.

In an example, after receiving the PEI configuration related to the inactive multicast service transmitted by the network device, the terminal may receive a PEI according to the PEI configuration related to the inactive multicast service, that is, may perform step S220.

In step S220, the terminal receives the PEI according to the PEI configuration related to the inactive multicast service.

In some implementations, the terminal may receive the PEI according to the PEI configuration related to the inactive multicast service, that is, in a case where the PEI configuration related to the inactive multicast service is stored by the terminal, the terminal may receive, according to the PEI configuration related to the inactive multicast service, a PEI configured to inform the terminal whether to monitor a paging message related to the inactive multicast service.

In an example, in a case where the terminal receives a PEI according to the PEI configuration related to the inactive multicast service, it may be determined that the PEI received by the terminal is configured to inform the terminal whether to monitor the paging message related to the inactive multicast service.

In another example, in a case where the terminal receives a PEI according to the PEI configuration related to the inactive multicast service and a Paging Early Indication Radio Network Temporary Identifier (PEI-RNTI) related to the inactive multicast service, it may further be determined that the PEI received by the terminal is configured to inform the terminal whether to monitor the paging message related to the inactive multicast service.

In another example, in a case where the terminal receives a PEI according to the PEI configuration related to the inactive multicast service and network indication information (e.g., DCI indication) transmitted by the network device is received by the terminal, it may further be determined that the PEI received by the terminal is configured to inform the terminal whether to monitor the paging message related to the inactive multicast service. The network indication information is configured to inform the terminal whether the PEI is a PEI related to the inactive multicast service.

In another example, in a case where the terminal receives a PEI according to the PEI configuration related to the inactive multicast service and the PEI-RNTI related to the inactive multicast service, it may be further determined, in a case where network indication information (e.g., DCI indication) transmitted by the network device is received, that the PEI received by the terminal is configured to inform the terminal whether to monitor the paging message related to the inactive multicast service. The network indication information is configured to inform the terminal whether the PEI is a PEI related to the inactive multicast service.

In another example, the terminal may receive a PEI according to a PEI configuration of existing R17 and the PEI-RNTI related to the inactive multicast service. Additionally, it may be determined that the PEI received by the terminal is configured to inform the terminal whether to monitor the paging message related to the inactive multicast service.

In another example, the terminal may receive a PEI according to the PEI configuration of the existing R17 and the PEI-RNTI related to the inactive multicast service. Further, the terminal may receive network indication information (e.g., DCI indication) transmitted by the network device, where the network indication information is configured to inform the terminal whether the PEI is a PEI related to the inactive multicast service. In an embodiment of the present disclosure, the terminal may further determine that the PEI received by the terminal is configured to inform the terminal whether to monitor the paging message related to the inactive multicast service.

In another example, the terminal may receive a PEI according to the PEI configuration of the existing R17 and a PEI-RNTI of the R17. Further, the terminal may receive network indication information (e.g., DCI indication) transmitted by the network device, where the network indication information is configured to inform the terminal whether the PEI is a PEI related to the inactive multicast service. In an embodiment of the present disclosure, the terminal may further determine, according to the network indication information (e.g., DCI indication) transmitted by the network device, whether the PEI received by the terminal is configured to inform the terminal to monitor the paging message related to the inactive multicast service or to not monitor the paging message related to the inactive multicast service.

Through the above introduction, it is known that in a case of being in the inactive state, the terminal may also continue to perform the reception of the multicast service data. In this process, the terminal may receive the PEI transmitted by the network device. Based on this, in a case where the PEI indicates to monitor a paging message related to an inactive multicast service, the terminal monitors the paging message related to the inactive multicast service on a PO after receiving the PEI.

In an example, in a case where the paging message related to the inactive multicast service is monitored by the terminal on the PO, the terminal may perform according to the paging message at least one of the following operations including but not limited to: updating a configuration for the inactive multicast service; activating a configuration for the inactive multicast service; deactivating a configuration for the inactive multicast service; releasing a configuration for the inactive multicast service; or suspending a configuration for the inactive multicast service.

It is to be noted that the format of DCI in an embodiment of the present disclosure may be an existing DCI format 2_7, or may be a newly defined DCI format.

FIG. 5 is a communication sequence diagram of a method for paging early indication (PEI) according to other embodiments. As shown in FIG. 5, the terminal 01 may receive a PEI configuration related to an inactive multicast service transmitted by a network device 02. Based on this, the terminal 01 may receive a PEI according to the PEI configuration related to the inactive multicast service, where the PEI is configured to inform the terminal 01 whether to monitor a paging message related to the inactive multicast service.

An embodiment of the present disclosure specifies that the terminal may receive a PEI transmitted by a network device according to the PEI configuration related to the inactive multicast service, where the PEI is configured to inform the terminal whether to monitor a paging message related to the inactive multicast service. In this way, the power consumption of monitoring the paging message related to the inactive multicast service can be reduced.

FIG. 6 is a flowchart of a method for paging early indication (PEI) according to yet other embodiments. As shown in FIG. 6, the method for paging early indication (PEI) may be performed by the terminal 01 in FIG. 2, and includes the following step S310.

In step S310, the terminal receives the PEI according to a PEI-RNTI related to the inactive multicast service.

In an embodiment of the present disclosure, the terminal may receive the PEI according to a PEI-RNTI related to the inactive multicast service. The PEI-RNTI may be a newly defined PEI specific to the inactive multicast service, and the PEI-RNTI may be specified by a protocol.

In an example, in a case of receiving a PEI according to the PEI-RNTI related to the inactive multicast service, the terminal may determine that the PEI received by the terminal is configured to inform the terminal whether to monitor a paging message related to the inactive multicast service.

In another example, in a case of receiving a PEI according to the PEI-RNTI related to the inactive multicast service and the PEI configuration related to the inactive multicast service, the terminal may further determine that the PEI received by the terminal is configured to inform the terminal whether to monitor the paging message related to the inactive multicast service. The PEI configuration related to the inactive multicast service may include at least one of a number of paging monitoring occasions associated with each PEI (po-Num Per PEI); PEI frame offset (pei-Frame Offset); payload size of downlink control information related to PEI (payload Size DCI); subgroup configuration (subgroup Config); or indication for monitoring PEI (last Used Cell Only).

In another example, in a case where the terminal receives a PEI according to the PEI-RNTI related to the inactive multicast service and network indication information (e.g., DCI indication) transmitted by the network device is received by the terminal, the terminal may further determine, according to the network indication information, that the PEI received by the terminal is configured to inform the terminal whether to monitor the paging message related to the inactive multicast service. The network indication information is configured to inform the terminal whether the PEI is a PEI related to the inactive multicast service.

In another example, in a case where the terminal receives a PEI according to the PEI-RNTI related to the inactive multicast service and the PEI configuration related to the inactive multicast service, the terminal may further determine according to network indication information, in a case where the network indication information (e.g., DCI indication) transmitted by the network device is received, that the PEI received by the terminal is configured to inform the terminal whether to monitor the paging message related to the inactive multicast service. The network indication information is configured to inform the terminal whether the PEI is a PEI related to the inactive multicast service.

In an example, the terminal may receive a PEI according to a PEI-RNTI of the existing R17 and the PEI configuration related to the inactive multicast service. Additionally, in an embodiment of the present disclosure, the terminal may determine that the PEI received by the terminal is configured to inform the terminal whether to monitor the paging message related to the inactive multicast service.

In another example, the terminal may receive a PEI according to the PEI-RNTI of the existing R17 and the PEI configuration related to the inactive multicast service. Further, the terminal may receive network indication information (e.g., DCI indication) transmitted by the network device, where the network indication information is configured to inform the terminal whether the PEI is a PEI related to the inactive multicast service. In an embodiment of the present disclosure, the terminal may further determine that the PEI received by the terminal is configured to inform the terminal whether to monitor the paging message related to the inactive multicast service.

In another example, the terminal may receive a PEI according to the PEI-RNTI of the existing R17 and the PEI configuration of the existing R17. Further, the terminal may receive network indication information (e.g., DCI indication) transmitted by the network device, where the network indication information is configured to inform the terminal whether the PEI is a PEI related to the inactive multicast service. In an embodiment of the present disclosure, the terminal may further determine, according to the network indication information (e.g., DCI indication) transmitted by the network device, whether the PEI received by the terminal is configured to inform the terminal to monitor the paging message related to the inactive multicast service or to not monitor the paging message related to the inactive multicast service.

Through the above introduction, it is known that in a case of being in the inactive state, the terminal may also continue to perform the reception of the multicast service data. In this process, the terminal may receive the PEI transmitted by the network device. Based on this, in a case where the PEI indicates to monitor a paging message related to an inactive multicast service, the terminal monitors the paging message related to the inactive multicast service on a PO after receiving the PEI.

In an example, in a case where the paging message related to the inactive multicast service is monitored by the terminal on the PO, the terminal may perform according to the paging message at least one of the following operations including but not limited to: updating a configuration for the inactive multicast service; activating a configuration for the inactive multicast service; deactivating a configuration for the inactive multicast service; releasing a configuration for the inactive multicast service; or suspending a configuration for the inactive multicast service.

It needs to be noted that the format of DCI in an embodiment of the present disclosure may be an existing DCI format 2_7, or may be a newly defined DCI format.

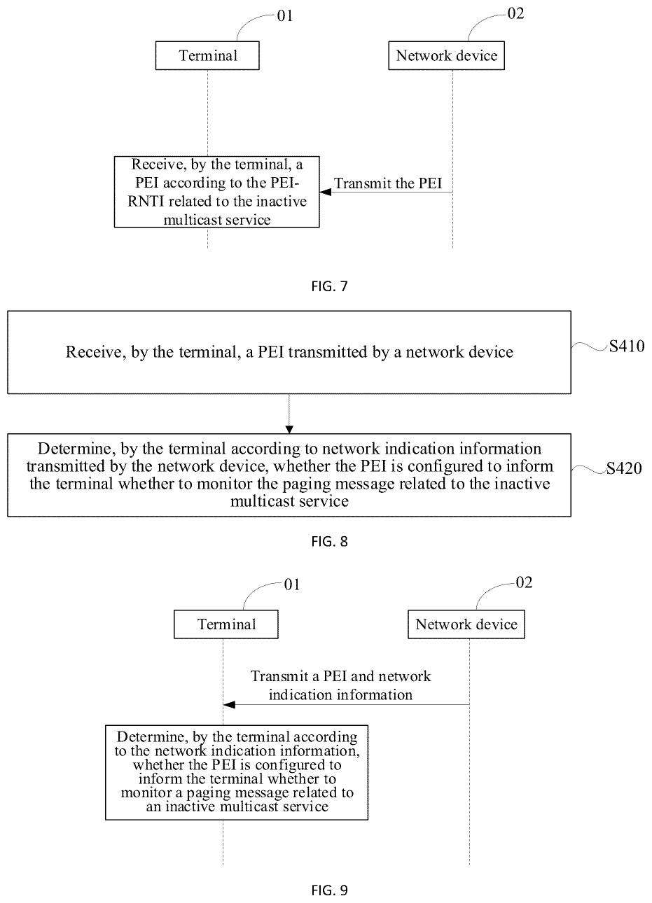

FIG. 7 is a communication sequence diagram of a method for paging early indication (PEI) according to yet other embodiments. As shown in FIG. 7, the terminal 01 may receive, according to a PEI-RNTI related to an inactive multicast service, a PEI transmitted by a network device 02.

An embodiment of the present disclosure specifies that the terminal may receive, according to the PEI-RNTI related to the inactive multicast service, a PEI transmitted by a network device, where the PEI is configured to inform the terminal whether to monitor a paging message related to the inactive multicast service. In this way, the power consumption of monitoring the paging message related to the inactive multicast service can be reduced.

FIG. 8 is a flowchart of a method for paging early indication (PEI) according to still other embodiments. As shown in FIG. 8, the method for paging early indication (PEI) may be performed by the terminal 01 in FIG. 2, and includes the following steps S410-S420.

In step S410, the terminal receives a PEI transmitted by a network device.

In some implementations, the terminal may receive a PEI transmitted by a network device, where the PEI may be configured to inform the terminal whether to monitor a paging message related to an inactive multicast service or a paging message having other functions. In a case where the PEI transmitted by the network device is received and network indication information transmitted by the network device is also received by the terminal, the terminal may determine, according to the network indication information, whether the PEI is configured to inform the terminal to monitor the paging message related to the inactive multicast service or to not monitor the paging message related to the inactive multicast service, that is, perform step S420.

In step S420, the terminal determines, according to network indication information transmitted by the network device, whether the PEI is configured to inform the terminal to monitor the paging message related to the inactive multicast service or to not monitor the paging message related to the inactive multicast service.

In an example, the terminal may receive network indication information (e.g., DCI indication) transmitted by the network device, where the network indication information is configured to inform the terminal whether the PEI is a PEI related to the inactive multicast service, so as to determine whether the PEI received by the terminal is configured to inform the terminal to monitor the paging message related to the inactive multicast service or to not monitor the paging message related to the inactive multicast service.

It needs to be noted that the terminal may receive the PEI and the network indication information simultaneously, that is, the PEI and the network indication information may be transmitted to the terminal simultaneously. For example, both the PEI and the network indication information may be included in downlink control information (e.g., DCI). The network device may transmit the PEI and the network indication information to the terminal by transmitting the downlink control information. Alternatively, the PEI and the network indication information may also be transmitted to the terminal separately. For example, the terminal receives the PEI first and then receives the network indication information. How to receive the PEI and the network indication information is not limited, and may be selected according to actual situation.

In an embodiment of the present disclosure, the terminal may receive network indication information (e.g., DCI indication) transmitted by the network device, where the network indication information is configured to inform the terminal whether the PEI is a PEI related to the inactive multicast service. In this way, the terminal may determine, according to the network indication information (e.g., DCI indication) transmitted by the network device, whether the PEI received by the terminal is configured to inform the terminal to monitor the paging message related to the inactive multicast service or to not monitor the paging message related to the inactive multicast service.

In another example, in a case where the network indication information transmitted by the network device and configured to inform the terminal whether the PEI is a PEI related to the inactive multicast service is received by the terminal, the terminal may further determine, in a case of receiving the PEI according to the PEI configuration related to the inactive multicast service, that the PEI received by the terminal is configured to inform the terminal whether to monitor the paging message related to the inactive multicast service. The PEI configuration related to the inactive multicast service may include at least one of a number of paging monitoring occasions associated with each PEI (po-Num Per PEI); PEI frame offset (pei-Frame Offset); payload size of downlink control information related to PEI (payload Size DCI); subgroup configuration (subgroup Config); or indication for monitoring PEI (last Used Cell Only).

In another example, in a case where the network indication information transmitted by the network device and configured to inform the terminal whether the PEI is a PEI related to the inactive multicast service is received by the terminal, the terminal may further determine, in a case of receiving the PEI according to the PEI-RNTI related to the inactive multicast service, that the PEI received by the terminal is configured to inform the terminal whether to monitor the paging message related to the inactive multicast service.

In another example, in a case where the network indication information transmitted by the network device and configured to inform the terminal whether the PEI is a PEI related to the inactive multicast service is received by the terminal, the terminal may further determine, in a case of receiving the PEI according to the PEI configuration related to the inactive multicast service and the PEI-RNTI related to the inactive multicast service, that the PEI received by the terminal is configured to inform the terminal whether to monitor the paging message related to the inactive multicast service.

In an example, in a case where the network indication information transmitted by the network device and configured to inform the terminal whether the PEI is a PEI related to the inactive multicast service is not received by the terminal, the terminal may additionally determine, in a case of receiving the PEI according to the PEI configuration related to the inactive multicast service, that the received PEI is configured to inform the terminal whether to monitor the paging message related to the inactive multicast service.

In an example, in a case where the network indication information transmitted by the network device and configured to inform the terminal whether the PEI is a PEI related to the inactive multicast service is not received by the terminal, the terminal may further determine, in a case of receiving the PEI according to the PEI configuration related to the inactive multicast service and the PEI-RNTI related to the inactive multicast service, that the PEI received by the terminal is configured to inform the terminal whether to monitor the paging message related to the inactive multicast service.

In an example, in a case where the network indication information transmitted by the network device and configured to inform the terminal whether the PEI is a PEI related to the inactive multicast service is not received by the terminal, the terminal may further determine, in a case of receiving the PEI according to the PEI-RNTI related to the inactive multicast service, that the PEI received by the terminal is configured to inform the terminal whether to monitor the paging message related to the inactive multicast service.

Through the above introduction, it is known that in a case of being in the inactive state, the terminal may also continue to perform the reception of the multicast service data. In this process, the terminal may receive the PEI transmitted by the network device. Based on this, in a case where the PEI indicates to monitor a paging message related to an inactive multicast service, the terminal monitors the paging message related to the inactive multicast service on a PO after receiving the PEI.

In an example, in a case where the paging message related to the inactive multicast service is monitored by the terminal on the PO, the terminal may perform according to the paging message at least one of the following operations including but not limited to: updating a configuration for the inactive multicast service; activating a configuration for the inactive multicast service; deactivating a configuration for the inactive multicast service; releasing a configuration for the inactive multicast service; or suspending a configuration for the inactive multicast service.

It needs to be noted that the format of DCI in an embodiment of the present disclosure may be an existing DCI format 2_7, or may be a newly defined DCI format.

FIG. 9 is a communication sequence diagram of a method for paging early indication (PEI) according to still other embodiments. As shown in FIG. 9, the terminal 01 may receive a PEI and network indication information transmitted by a network device 02. Based on this, the terminal 01 may determine, according to the network indication information transmitted by the network device 02, whether the PEI received by the terminal is configured to indicate to monitor a paging message related to an inactive multicast service or to not monitor the paging message related to the inactive multicast service.

An embodiment of the present disclosure specifies that the terminal may determine, according to the network indication message transmitted by the network device, that the PEI received by the terminal is configured to inform the terminal whether to monitor the paging message related to the inactive multicast service. In this way, the power consumption of monitoring the paging message related to the inactive multicast service can be reduced.

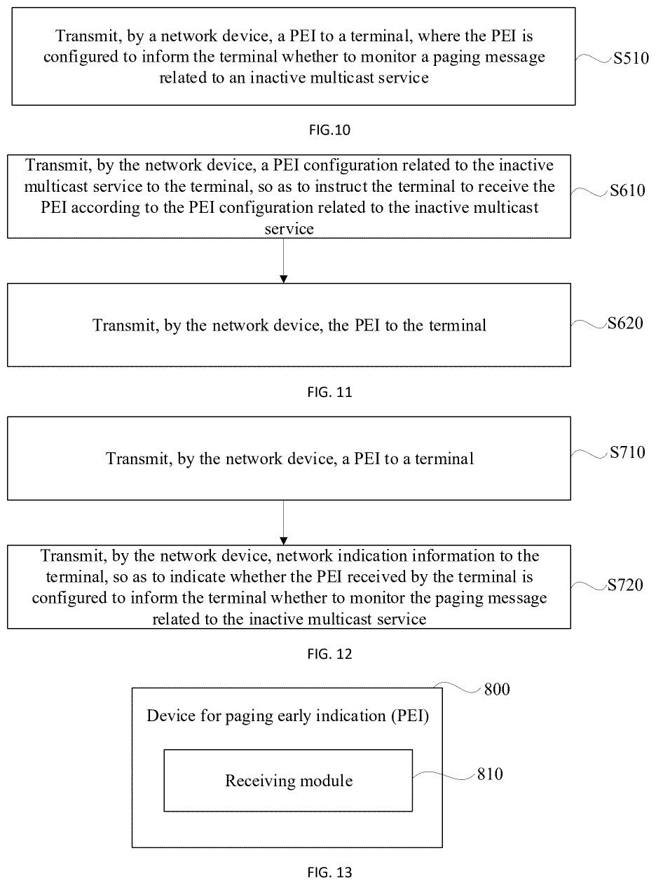

FIG. 10 is a flowchart of a method for paging early indication (PEI) according to some embodiments. As shown in FIG. 10, the method for paging early indication (PEI) may be performed by the network device 02 in FIG. 2, and includes the following step S510.

In step S510, the network device sends a PEI to a terminal, where the PEI is configured to inform the terminal whether to monitor a paging message related to an inactive multicast service.

In an embodiment of the present disclosure, the network device may transmit a PEI to a terminal, where the PEI is configured to inform the terminal whether to monitor a paging message related to an inactive multicast service. In this way, the power consumption of monitoring the paging message related to the inactive multicast service can be reduced.

FIG. 11 is a flowchart of a method for paging early indication (PEI) according to other embodiments. As shown in FIG. 11, the method for paging early indication (PEI) may be performed by the network device 02 in FIG. 2, and includes the following steps S610-S620.

In step S610, the network device transmits a PEI configuration related to the inactive multicast service to the terminal, so as to instruct the terminal to receive the PEI according to the PEI configuration related to the inactive multicast service.

In an embodiment of the present disclosure, the PEI configuration related to the inactive multicast service may include at least one of the following: a number of paging monitoring occasions associated with each PEI (po-Num Per PEI); PEI frame offset (pei-Frame Offset); payload size of downlink control information related to PEI (payload Size DCI); subgroup configuration (subgroup Config); or indication for monitoring PEI (last Used Cell Only).

In an example, the network device may transmit a PEI configuration related to the inactive multicast service to the terminal, so as to instruct the terminal to receive a PEI according to the PEI configuration related to the inactive multicast service. The PEI is configured to inform the terminal whether to monitor a paging message related to the inactive multicast service.

In step S620, the network device transmits the PEI to the terminal.

In an example, after transmitting a PEI configuration related to the inactive multicast service to the terminal, the network device may transmit a PEI to the terminal, and the terminal may receive the PEI based on the PEI configuration related to the inactive multicast service transmitted by the network device in advance. In this way, the power consumption of monitoring the paging message related to the inactive multicast service can be reduced.

FIG. 12 is a flowchart of a method for paging early indication (PEI) according to yet other embodiments. As shown in FIG. 12, the method for paging early indication (PEI) may be performed by the network device 02 in FIG. 2, and includes the following steps S710-S720.

In step S710, the network device transmits a PEI to a terminal.

In an embodiment of the present disclosure, the PEI may be configured to inform the terminal whether to monitor a paging message related to an inactive multicast service. In addition, the PEI may also be other paging early indication information.

In step S720, the network device transmits network indication information to the terminal, so as to indicate whether the PEI received by the terminal is configured to inform the terminal to monitor the paging message related to the inactive multicast service or to not monitor the paging message related to the inactive multicast service.

In an example, in a case of transmitting the PEI to the terminal, the network device may also transmit the network indication information to the terminal, so as to instruct the terminal to determine, according to the network indication information, whether the PEI received by the terminal is configured to inform the terminal to monitor the paging message related to the inactive multicast service or to not monitor the paging message related to the inactive multicast service. In this way, the power consumption of monitoring the paging message related to the inactive multicast service can be further reduced.

FIG. 13 is a block diagram of a device 800 for paging early indication (PEI) according to some embodiments. Referring to FIG. 13. The device 800 for paging early indication (PEI) is applied to a terminal, and the device 800 for paging early indication (PEI) may include a receiving module 810.

The receiving module 810 is configured to receive a PEI transmitted by a network device, where the PEI is configured to inform the terminal whether to monitor a paging message related to an inactive multicast service.

In some implementations, the paging message related to the inactive multicast service is configured to inform the terminal to perform at least one of the following operations: updating a configuration for the inactive multicast service; activating a configuration for the inactive multicast service; deactivating a configuration for the inactive multicast service; releasing a configuration for the inactive multicast service; or suspending a configuration for the inactive multicast service.

In some implementations, the receiving module 810 may include: a configuration receiving submodule, configured to receive a PEI configuration related to an inactive multicast service transmitted by the network device; and a first PEI receiving submodule, configured to receive the PEI according to the PEI configuration related to the inactive multicast service.

In some implementations, the PEI configuration related to the inactive multicast service includes at least one of: a number of paging monitoring occasions associated with each PEI; PEI frame offset; payload size of downlink control information related to the PEI; subgroup configuration; or indication for monitoring the PEI.

In some implementations, the receiving module 810 may further include: a second PEI receiving submodule, configured to receive the PEI according to a PEI-RNTI related to the inactive multicast service.

In some implementations, the device 800 for paging early indication (PEI) may further include: a determination module (not shown), configured to determine, according to the network indication information transmitted by the network device, whether the PEI is configured to inform the terminal to monitor a paging message related to the inactive multicast service or to not monitor the paging message related to the inactive multicast service.

In an embodiment of the present disclosure, by receiving a PEI transmitted by a network device, the terminal may reduce the power consumption of monitoring a paging message related to an inactive multicast service, where the PEI is configured to inform the terminal whether to monitor the paging message related to the inactive multicast service.

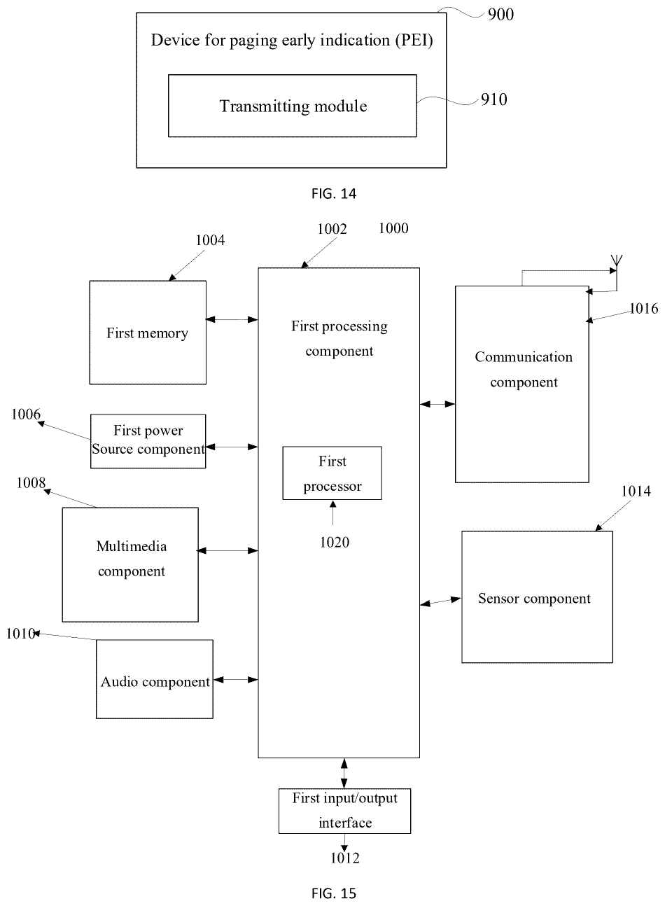

FIG. 14 is a block diagram of a device 900 for paging early indication (PEI) according to some embodiments. Referring to FIG. 14, the device 900 for paging early indication (PEI) is applied to a network device, and the device 900 for paging early indication (PEI) may include a transmitting module 910.

The transmitting module 910 is configured to transmit a PEI to a terminal, where the PEI is configured to inform the terminal whether to monitor a paging message related to an inactive multicast service.

In some implementations, the device 900 for paging early indication (PEI) may further include: an indication information transmitting module (not shown), configured to transmit network indication information to the terminal, so as to indicate whether the PEI received by the terminal is configured to inform the terminal to monitor the paging message related to the inactive multicast service or to not monitor the paging message related to the inactive multicast service.

In some implementations, the device 900 for paging early indication (PEI) may further include: a configuration transmitting module (not shown), configured to transmit a PEI configuration related to the inactive multicast service to the terminal, so as to instruct the terminal to receive the PEI according to the PEI configuration related to the inactive multicast service.

In an embodiment of the present disclosure, by transmitting a PEI to a terminal by the network device, the power consumption of monitoring a paging message related to an inactive multicast service may be reduced, where the PEI is configured to inform the terminal whether to monitor the paging message related to the inactive multicast service.

With regard to the devices in the above embodiments, the specific mode in which each module performs operations has been described in detail in the embodiments of the methods, which will not be described in detail.

The present disclosure further provides a non-transitory computer-readable storage medium storing computer program instructions, where the computer program instructions, when executed by one or more processors, implement the steps of the method for paging early indication (PEI) provided by the present disclosure.

FIG. 15 is a block diagram of a terminal 1000 according to some embodiments. For example, the terminal 1000 may be a mobile phone, a computer, a digital broadcast terminal, a message transceiving device, a game console, a tablet device, a medical device, a fitness device, a personal digital assistant, a smart car, etc.

Referring to FIG. 15, the terminal 1000 may include one or more of the following components: a first processing component 1002, a first memory 1004, a first power source component 1006, a multimedia component 1008, an audio component 1010, a first input/output interface 1012, a sensor component 1014, and a communication component 1016.

The first processing component 1002 generally controls the overall operations of the terminal 1000, such as operations associated with display, telephone call, data communication, camera operations, and recording operations. The first processing component 1002 may include one or more first processors 1020 to execute instructions so as to complete all or some of the steps of the method for paging early indication (PEI). In addition, the first processing component 1002 may include one or more modules to facilitate the interaction between the first processing component 1002 and other components. For example, the processing component 1002 may include a multimedia module to facilitate the interaction between the multimedia component 1008 and the first processing component 1002.

The first memory 1004 is configured to store various types of data to support an operation on the terminal 1000. Examples of these data include instructions for any application program or method for operation on the terminal 1000, contact person data, telephone directory data, messages, pictures, videos, etc. The first memory 1004 may be implemented by any type of volatile or non-volatile storage device or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or a compact disc.

The first power source component 1006 provides power to various components of the terminal 1000. The power source component 1006 may include a power source management system, one or more power sources, and other components associated with generating, managing and distributing power for the terminal 1000.

The multimedia component 1008 includes a screen between the terminal 1000 and a user, which provides an output interface. In some embodiments, the screen may include a Liquid Crystal Display (LCD) and a Touch Panel (TP). In a case of including the touch panel, the screen may be implemented as a touch screen to receive an input signal from the user. The touch panel includes one or more touch sensors to sense touch, sliding, and a gesture on the touch panel. The touch sensor may not only sense the boundary of a touch or sliding action, but also detect a duration and pressure related to the touch or sliding action. In some embodiments, the multimedia component 1008 includes a front-facing camera and/or a rear-facing camera. In a case where the terminal 1000 is in an operation mode such as a shooting mode or a video mode, the front-facing camera and/or the rear-facing camera may receive external multimedia data. Each of the front camera and the rear camera may be a fixed optical lens system or have focal length and optical zoom capability.

The audio component 1010 is configured to output and/or input an audio signal. For example, the audio component 1010 includes a Microphone (MIC) configured to receive an external audio signal in a case where the terminal 1000 is in an operation mode, such as a call mode, a recording mode and a voice recognition mode. The received audio signal may be further stored in the first memory 1004 or transmitted via the communication component 1016. In some embodiments, the audio component 1010 further includes a speaker for outputting an audio signal.

The first input/output interface 1012 provides an interface between the processing component 1002 and peripheral interface modules which may be keyboards, click wheels, buttons, etc. These buttons may include, but are not limited to, a home button, a volume button, a start button, and a lock button.

The sensor component 1014 includes one or more sensors, configured to provide state evaluation of various aspects for the terminal 1000. For example, the sensor component 1014 may detect an on/off state of the terminal 1000, and the relative positioning of components, for example, a display and a keypad of the terminal 1000; the sensor component 1014 may also detect the position change of the terminal 1000 or one component of the terminal 1000, the presence or absence of contact between the user and the terminal 1000, the orientation or acceleration/deceleration of the terminal 1000, and the temperature change of the terminal 1000. The sensor component 1014 may include a proximity sensor configured to detect the presence of a nearby object without any physical contact. The sensor component 1014 may further include an optical sensor, such as a CMOS or CCD image sensor, configured to be used in imaging applications. In some embodiments, the sensor component 1014 may further include an acceleration sensor, a gyro sensor, a magnetic sensor, a pressure sensor, or a temperature sensor.

The communication component 1016 is configured to facilitate wired or wireless communication between the terminal 1000 and other devices. The terminal 1000 may access a communication standard-based wireless network, such as Wi-Fi, 2G or 3G, or a combination thereof. In an example, the communication component 1016 receives a broadcast signal or broadcast related information from an external broadcast management system via a broadcast channel. In an example, the communication component 1016 further includes a Near Field Communication (NFC) module to facilitate short-range communication, which may be implemented in the NFC module based on a Radio Frequency Identification (RFID) technology, an Infrared Data Association (IrDA) technology, an Ultra-Wideband (UWB) technology, a Bluetooth (BT) technology and other technologies, for example.

In an example, the terminal 1000 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components to perform the method for paging early indication (PEI).

In an example, a non-transitory computer-readable storage medium including instructions, such as the memory 1004 including instructions, is further provided. The instructions may be executed by the first processor 1020 of the terminal 1000 to implement the method for paging early indication (PEI). For example, the non-transitory computer-readable storage medium may be an ROM, a Random Access Memory (RAM), a CD-ROM, a magnetic tape, a floppy disk, an optical data storage device, etc.

In addition to being an independent electronic device, the device may also be a part of an independent electronic device. For example, in one embodiment, the device may be an Integrated Circuit (IC) or a chip, where the integrated circuit may be one IC or a collection of a plurality of ICs; the chip may include but is not limited to the following types: a Graphics Processing Unit (GPU), a Central Processing Unit (CPU), a Field Programmable Gate Array (FPGA), a Digital Signal Processor (DSP), an Application Specific Integrated Circuit (ASIC), a System on Chip (SOC), etc. The above integrated circuit or chip may be used to execute executable instructions (or codes) to implement the method for paging early indication (PEI). The executable instructions may be stored in the integrated circuit or chip, and may also be acquired from other devices or equipment. For example, the integrated circuit or chip includes a processor, a memory, and an interface for communicating with other devices. The executable instructions may be stored in the memory, where the executable instructions, when executed by the processor, implement the method for paging early indication (PEI). Alternatively, the integrated circuit or chip may receive the executable instructions through the interface and transmit the executable instructions to the processor for execution, so as to implement the method for paging early indication (PEI).

In another example, a computer program product is further provided. The computer program product includes a computer program executable by a programmable device, where the computer program has a code portion for performing the method(s) for paging early indication (PEI) when performed by the programmable device.

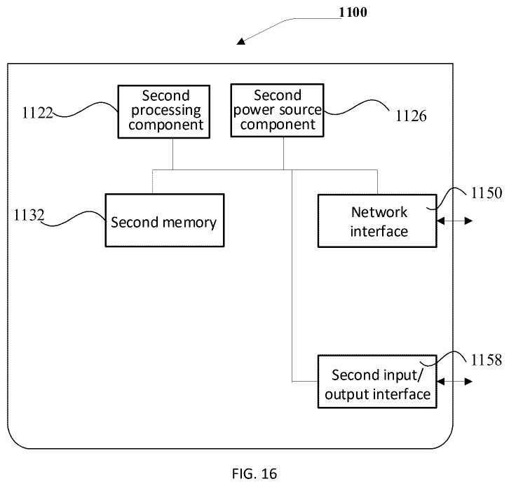

FIG. 16 is a block diagram of a network device 1100 according to an example. For example, the network device 1100 may be provided as a server. Referring to FIG. 16, the communication device 1100 includes a second processing component 1122, and further includes one or more processors, and a memory resource represented by a second memory 1132, configured to store executable instructions of the second processing component 1122, such as an application. The application stored in the second memory 1132 may include one or more modules each corresponding to a set of instructions. In addition, the second processing component 1122 is configured to execute instructions so as to perform the method for paging early indication (PEI).

The network device 1100 may further include a second power source component 1126 configured to perform power source management of the network device 1100, a wired or wireless network interface 1150 configured to connect the network device 1100 to a network, and a second input/output interface 1158. The network device 1100 may operate based on an operating system stored in the memory 1132, such as Windows Server™, Mac OS X™, Unix™, Linux™, FreeBSD™, or the like.

The technical solutions provided by the embodiments of the present disclosure may include the following beneficial effect: the power consumption of monitoring a paging message related to an inactive multicast service may be reduced by receiving a PEI transmitted by a network device, where the PEI is configured to indicate whether a terminal monitors the paging message related to the inactive multicast service.

Those skilled in the art will readily conceive of other implementation solutions of the present disclosure after considering the specification and practicing the present disclosure. This application is intended to cover all variations, uses or adaptive changes of the present disclosure, which follow the general principles of the present disclosure and include common knowledge or conventional technical means in the technical field not disclosed in the present disclosure. The specification and embodiments are merely considered to be exemplary, and the true scope and spirit of the present disclosure are indicated by the following claims.

It is to be understood that the present disclosure is not limited to a precise structure described herein and shown in the accompanying drawings, and various modifications and changes can be made without departing from the scope thereof. The scope of the present disclosure is limited merely by the appended claims.

1. A method for paging early indication (PEI), performed by a terminal, comprising:
receiving a PEI transmitted by a network device, wherein the PEI is configured to inform the terminal whether to monitor a paging message related to an inactive multicast service.

2. The method according to claim 1, wherein the paging message related to the inactive multicast service is configured to inform the terminal to perform at least one of the following operations:
updating a configuration for the inactive multicast service;
activating a configuration for the inactive multicast service;
deactivating a configuration for the inactive multicast service;
releasing a configuration for the inactive multicast service; or
suspending a configuration for the inactive multicast service.

3. The method according to claim 1, wherein receiving the PEI transmitted by the network device comprises:
receiving a PEI configuration related to the inactive multicast service transmitted by the network device; and
receiving the PEI according to the PEI configuration related to the inactive multicast service.

4. The method according to claim 3, wherein the PEI configuration related to the inactive multicast service comprises at least one of:
a number of paging monitoring occasions associated with each PEI;
PEI frame offset;
payload size of downlink control information related to the PEI;
subgroup configuration; or
indication for monitoring the PEI.

5. The method according to claim 1, wherein receiving the PEI transmitted by the network device comprises:
receiving the PEI according to a Paging Early Indication Radio Network Temporary Identifier (PEI-RNTI) related to the inactive multicast service.

6. The method according to claim 1, wherein the method further comprises:
determining, according to network indication information transmitted by the network device, whether the PEI is configured to inform the terminal to monitor the paging message related to the inactive multicast service or to not monitor the paging message related to the inactive multicast service.

7. A method for paging early indication (PEI), performed by a network device, comprising:
transmitting a PEI to a terminal, wherein the PEI is configured to inform the terminal whether to monitor a paging message related to an inactive multicast service.

8. The method according to claim 7, wherein the method further comprises:
transmitting a PEI configuration related to the inactive multicast service to the terminal, to instruct the terminal to receive the PEI according to the PEI configuration related to the inactive multicast service.

9. The method according to claim 7, wherein the method further comprises:
transmitting network indication information to the terminal, to indicate whether the PEI received by the terminal is configured to inform the terminal to monitor the paging message related to the inactive multicast service or to not monitor the paging message related to the inactive multicast service.

10.-11. (canceled)

12. A terminal, comprising:
one or more processors; and
a memory configured to store processor-executable instructions, and
wherein the one or more processors are configured to execute the processor-executable instructions to cause the terminal to:
receive a paging early indication (PEI) transmitted by a network device, wherein the PEI is configured to inform the terminal whether to monitor a paging message related to an inactive multicast service.

13. A network device, comprising:
one or more processors; and
a memory configured to store processor-executable instructions, and
wherein the one or more processors are configured to perform the processor-executable instructions to implement the method according to claim 7.

14. A non-transitory computer-readable storage medium storing computer program instructions, wherein the computer program instructions, when executed by one or more processing devices, implement the method according to claim 1.

15. A chip, comprising one or more processors and an interface, wherein the one or more processors are configured to read instructions to perform the method according to claim 1.

16. A non-transitory computer-readable storage medium storing computer program instructions, wherein the computer program instructions, when executed by one or more processing devices, implement the method according to claim 7.

17. A chip, comprising one or more processors and an interface, wherein the one or more processors are configured to read instructions to perform the method according to claim 7.

18. The terminal according to claim 12, wherein the one or more processors are further configured to:
receive a PEI configuration related to the inactive multicast service transmitted by the network device; and
receive the PEI according to the PEI configuration related to the inactive multicast service.

19. The terminal according to claim 12, wherein the one or more processors are further configured to:
receive the PEI according to a Paging Early Indication Radio Network Temporary Identifier (PEI-RNTI) related to the inactive multicast service.

20. The terminal according to claim 12, wherein the one or more processors are further configured to:
determine, according to network indication information transmitted by the network device, whether the PEI is configured to inform the terminal to monitor the paging message related to the inactive multicast service or to not monitor the paging message related to the inactive multicast service.

21. The network device according to claim 13, wherein the one or more processors are further configured to:
transmit a PEI configuration related to the inactive multicast service to the terminal, to instruct the terminal to receive the PEI according to the PEI configuration related to the inactive multicast service.

22. The network device according to claim 13, wherein the one or more processors are further configured to:
transmit network indication information to the terminal, to indicate whether the PEI received by the terminal is configured to inform the terminal to monitor the paging message related to the inactive multicast service or to not monitor the paging message related to the inactive multicast service.
